(19) United States
(12) Patent Application Publication
(10) Pub. No.: US 2008/0232270 A1
(43) Pub. Date: Sep. 25, 2008

(54) Systems and arrangements for power conservation in network devices

(76) Inventors: Kristoffer Fleming, Chandler, AZ (US); David Leeper, Scottsdale, AZ (US); Chang Yong Kang, Chandler, AZ (US)

Correspondence Address: SCHUBERT, OSTERRIEDER & NICKELSON, PLLC;c/o Intellevate, LLC, P.O. BOX 52050, MINNEAPOLIS, MN, 55402, US

(21) Appl. No.: 11/726,442

(22) Filed: Mar. 22, 2007

(51) Int. Cl. H04L 12/28

(52) U.S. Cl. 370/254

(57) ABSTRACT

Arrangements for a reduced power consumption network device are disclosed. In one embodiment, the device can join the network by communicating with a second network compatible device. After the network connection is made the device can place communication configuration or network status processing components in a low power mode until the device detects an indication of a status change in a communication from the second device. When the status change is detected the device can activate the status processing components that were placed in the low power mode and these processing components can process the status change information to change a communication configuration. Significant power saving can be achieved by placing such components into the sleep mode.

### FIELD

The present disclosure relates generally to wireless communications in a network environment. More particularly, embodiments of the present disclosure are in the field of power management for network devices.

### BRIEF DESCRIPTION OF THE DRAWINGS

Aspects of the invention will become apparent upon reading the following detailed description and upon reference to the accompanying drawings in which, like references may indicate similar elements:

FIG. 1 depicts an embodiment of a network such as a wireless personal area network;

FIG. 2 is a timing diagram illustrating a possible signaling format for network devices;

FIG. 3 includes graphs representing exemplary correlator outputs for different preambles; and,

FIG. 4 is a flow diagram that provides methods that can be utilized to facilitate power conservation for network devices.

### DETAILED DESCRIPTION OF EMBODIMENTS

The following is a detailed description of embodiments of the disclosure depicted in the accompanying drawings. The embodiments are introduced in such detail as to clearly communicate the disclosure. However, the embodiment(s) presented herein are merely illustrative, and are not intended to limit the anticipated variations of such embodiments; on the contrary, the disclosure is to cover all modifications, equivalents, and alternatives falling within the spirit and scope of the appended claims.

While specific embodiments will be described below with reference to particular configurations of hardware and/or software, those of skill in the art will realize that embodiments of the present invention may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

The consumer demand for improved communication devices such as cellular telephones, personal digital assistants and hand held computers continues to grow. The battery life of such devices is an important operating parameter and one of the disclosed arrangements herein addresses such a deficiency. Network communications are generally dictated by standards and one standard for wireless network communications includes a WiMedia MAC standard, as defined in European Computer Manufacturers Association STD 386, (ECMA-368) entitled “High Rate Ultra Wideband PHY (physical layer) and MAC (Media Access Control). A superframe is define as part of the ECMA-368 standard

Generally, ECMA-368 compliant devices exchange information and agree upon a communication structure in a beaconing process where the information will dictate a communication configuration to be utilized during subsequent communications. Such a structure can also change with time. For example, the beaconing process could signal a reservation changes, and Internet protocol traffic indications change or an informative changes to alter the mode of communication all which could modify the communication structure. Thus, in a WiMedia based systems that is fairly dormant, a significant part of overall ultra wide band (UWB) transceiver power consumption is devoted to processing a beacon signal from other UWB transmitters in the network. Generally, such a beacon processing is critical when devices are attempting to join the network or network connected devices are reporting some kind of status change. However, the majority of the time, there is no new information in the beacon and in response to a beacon the mobile device will come out of the sleep mode process the beacon only to find out that there is no new information. The device will burn a significant amount of power during this process.

If the device could remain in a sleep mode when no new status information is being transmitted and not have to process the beacon, the device could conserve a significant amount of power. In accordance with the present disclosure indicators can be added to a preamble portion of the beacon to indicate that there is no status change or no new information in the beacon and “power hungry” components that are normally placed in an active mode for each beacon reception can remain in a sleep mode thereby significantly extending battery life in a mobile device. This feature allows smaller-less expensive batteries to be utilized in the device.

To stay compatible with legacy systems when there is a change to the status of the network as indicated in the preamble no “remain in sleep mode” indicators will be present in the preamble and the new information can be received by the mobile device and this status information can be processed by the device and stored in the memory of the device to facilitate forthcoming or pending communications in accordance with the standards listed above. It can be appreciated that typically the vast majority of beacon transmissions do not require any action or processing that will change the stored communication parameters in the receiving devices and thus the duty cycle of inefficient power burning components can be greatly reduced. It can also be appreciated that in traditional mobile devices, the device will process every beacon signal utilizing these power hungry status processing components as more than fourteen times a second.

In accordance with the present disclosure, when a mobile device transmits its beacon signal it can include in a preamble portion of the beacon signal an indicator that no new information is contained in the pending transmission. Devices receiving such an indication can keep high power components or circuits in a sleep mode, thus conserving significant energy during the majority of operation. As stated above, most beacon signals do not contain new information and this “change” or “no-change” status indicator in the preamble can be detected by the disclosed receiving devices which can remain in a sleep mode based on receiving a preamble with a no-change indicator.

The preamble is the precursor to the beacon to help receivers synchronize with the transmitter. The preamble does not carry any user generated information for example it does not consist of ones and zeros but it is a signal with a predetermined shape and many different preambles can be transmitted and received. The receivers can have correlators and each correlator can detect one of many predetermined preamble waveforms or shapes and based on the preamble activate or “let sleep” components in the mobile device.

These components can include parts of the receiver chain, such as analog to digital converters, fast Fourier transform processors, decoders, and portions of memory. These components can remain in a power conservation mode when no new beacon information is being transmitted without affecting system operation. When the indicator in the preamble provides that a status change will be coming (i.e. will be subsequently transmitted), in the beacon the network device can power up the beacon processing components mentioned above and a change parameters in its memory based on processing such a transmission. The status change information can be utilized in device coordination and device interaction during subsequent communications.

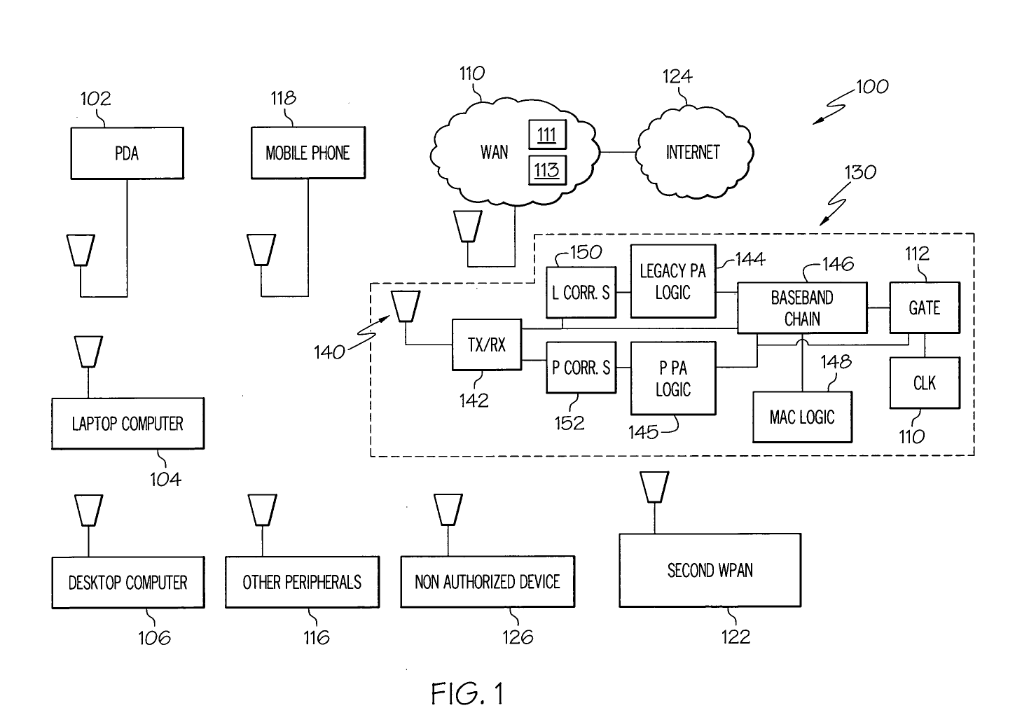

Referring to FIG. 1, a wireless legacy compliant network 100 having devices that can communicate “a forthcoming status change/no-change” information about the communication configuration possibly within a preamble of a beacon is disclosed. Wireless devices connected, and attempting to connect to the network 100 such as personal digital assistant (PDA) 102, mobile phone 118, laptop/handheld computer 104, desktop computer 106, network device 130 and other peripherals 116 such as an ipod® pocket video games, pagers, “MP3” player can transmit and receive beacons as part of a network set-up and maintenance procedure.

In accordance with the present disclosure, preambles can comply with existing specifications, yet can include additional indications that the subsequent beacon contains no new communication configuration information. This allows the arrangements described herein to be backward compatible such that legacy devices will still operate with the disclosed arrangements. Allowing non-legacy network devices or proactive network devices to ignore the balance of the transmission allows the disclosed proactive devices to keep power hungry internal components in a sleep mode when no new data is pending thereby saving significant power for a mobile device.

When a beacon is processed, the data in a beacon can dictate device status or communication configuration information such as transmission slot allocation and timing among other things for a device that will be transmitting. This information generally includes data that is not directly created or controlled by the user of the device, but information created and utilized by the devices to coordinate communications typically in accordance with an industry standard. Many of such wireless devices such as a PDA 102 can be carried in a pocket of an individual's clothes and communicate seamlessly via the network 100 without user intervention. The network 100 can include an access point 111 possibly located proximate to a wide area network (WAN) 110 that interface the network 100 with the Internet 124.

For example, status information from a device attempting to join the network can be utilized by devices in the network 102, 118, 104, 106 116 etc. as a detection mechanism to communicate the presence of a new and authorized devices that has moved within range of the network 100. In one embodiment, devices can enter the boundaries of the network 100 and then after a connection is made, or communication is established, portions of the connected devices can go into a sleep mode to conserve battery power. More specifically portions of the device that are specific to processing such beaconing or status information can be placed in a low power mode until “new” status information is transmitted by a device. Sometimes this new status information is transmitted by a device that is entering into the network 100 and other times it is transmitted by a device that has a task to perform such as when a user requests a device such as PDA 102 to perform a special communication via the Internet 124.

Network device 130 (enclosed by dashed line) illustrates a simplified block diagram of possible internal components of a network device. Thus, each network enabled device illustrated, 102, 118, 104, 106 116 can include the components illustrated in network device 130. One important aspect of networking technology is detecting devices that enter the network area and coordinating these devices to communicate with other devices connected to the network 100. This is commonly referred to as “plugging in.” In one scenario, when any two network compatible devices such as PDA 102 and laptop computer 104 come into close proximity (within several meters of each other) the devices 102 and 104 can communicate with each other as if they are hardwired together (i.e. connected by a cable). Such network compatible devices may be capable of, for example making phone calls, synchronizing data between each other, sending and receiving data in different formats such as a fax format and e-mail format, hypertext format and other format that can contain data files and executable code. Generally, any service or communication that can be performed over the Internet 124, in addition to other services, can be achieved over/via the network 100.

In one embodiment, the network device 130 can include a plurality of legacy correlators indicated by legacy correlators 150 and a plurality of proactive correlators indicated by proactive correlators 152. Each correlator in the groups of correlators 150 and 152 can be assigned to a specific channel or recognize a specific waveform in a preamble where multiple channels can be utilized by the network 100 depending on the number of connected devices. The legacy preamble correlator 150 represent a numerous legacy correlators each having a different transmit frequency codes (TFC)s for receiving different channels and processing signals on different channel frequencies. Likewise, the proactive preamble correlator 152 represents numerous proactive correlators having different TFCs that can receive beacons on different channels. In one embodiment, each channel has a particular spacing and each channel will hop to different frequencies based on a predetermined routine.

The preamble can carry information that indicates if the pending beacon will provide change content regarding a communication configuration. In one embodiment another preamble can be added to the original preamble, resulting in a composite preamble that has a different “shape” than the original preamble. The added preamble can be “orthogonal” to the original preamble, so that the legacy correlators 150 properly detect the original preamble although it is mixed in with or part of the composite preamble. A composite preamble may look totally different than a legacy preamble and a proactive correlator 152 that runs side-by-side with the legacy correlator 150 can detect the added preamble portion from the composite preamble.

Alternately described, two correlators, a legacy correlator and a proactive correlator can receive the composite preamble but the legacy correlator will only “see” the original preamble or the legacy preamble portion or component, whereas the proactive correlator may only see the added preamble component with the status indicator. Regardless the composite preamble can be backward compatible, meaning that legacy devices that only have legacy type correlators will function in the standard way in accordance with the appropriate specifications, waking up beacon processing components for every beacon. A device that has the proactive correlator can detect the presence of the additional “no-change” indicator or component in the preamble, to determine if the subsequent beacon has changed information or not and should be processed. It can be appreciated that the baseband receiver chain 146 when activated or clocked, can draw in excess of one (1) watt of power. Such high power consumption in a mobile device requires a larger more expensive battery and can severely limit the operating time between charges and battery life generally.

The network 100 can utilize ultra wide band (UWB) topology that spreads the communication channels over a wide band of frequencies. As stated above, UWB systems transmit on many different frequencies or channels and in one embodiment each correlator (150 and 152) can be assigned to a specific communication channel.

In operation, network device 130 can receive a preamble portion of a beacon transmission from another network device (i.e. 102, 104, 106, 118, 116, 110, and 122) via antenna 140, and process the transmission with transceiver 142. The output of the transceiver 142 can feed proactive correlators 152 and legacy correlators 105 and the correlators assigned to the active or selected channel can send a correlator output signal to the proactive preamble logic module (PPLM) 145 and the legacy preamble logic module (LPLM) 145 respectively. Accordingly this “pre-warning notice” of a device status change in the preamble 201 of a beacon transmission (the time in the designated slot before the cross hatched area, which is not cross hatched) can allow the proactive components to activate a baseband chain in time to receive the “new” status data during the balance of the superframe transmission. Clock 110 can feed the baseband chain 146 when the gate 112 is activated by the legacy preamble logic module 152. Thus, the gate 112 can be activated when the legacy preamble logic 145 determines that a beacon has been received and the beacon has new information that needs to be processed in order to stay current in the network.

In accordance with the present disclosure, a proactive correlator can receive a preamble of a beacon signal and determine if the balance of the transmission contains any new status information. The proactive correlator on the active channel that reorganizes the modified preamble can send a “change/no change” indicator to the PPLM 145 which can determine if a status change of a network parameter is forthcoming in the balance of the transmission. In one embodiment, the PPLM 145 can send a control signal to gate 112 which provides or passes a clock signal from clock 110 to the baseband chain 146, thereby activating the baseband chain 146 to process the information contained in the beacon. During processing of the beacon, the baseband chain 146 and the MAC logic 148 can extract and store the actual change in status information.

It can be appreciated that the disclosed arrangements are legacy complaint. Legacy components of device 130, such as 150 and 144, can facilitate establishing communication with the network 100. Then legacy components and components within device 130, that are utilized to process beacon data, can be placed in a sleep mode and can remain in a sleep mode until proactive components (for example 152 and 145) detect a change status indicator in the beacon and enable beacon processing components (for example 112 and 146). The teachings herein can also be applied to other types of systems or non ECMA-368 WiMedia MAC compliant systems that support wireless LAN systems. Devices that utilizes the systems and methods disclosed herein can signal directly to the media access control (MAC) portion of the system such as MAC logic 148 that a “no-change” indicator in the beacon has been received, avoiding “power-up” of the MAC logic 148 in addition to other components within the device 130.

In one embodiment, when a new device comes within range of a network 100 and is transmitting, the beacon from the new device can “awaken” the beacon processing components of a network connected device such that the connected device can process and store the change in status to the network in response to the new beacon. The beacon receiving and processing circuits in the baseband receiver chain 216, can be a component, a group of components, or a subsystem that can be remain at idle or remain in a sleep mode when no beacon data needs to be processed.

In one embodiment, the composite preamble can also include an indication of what kind of change will be transmitted or what type of change is present in the pending portion of the beacon. Thus, network devices can receive beacons from other network devices, and based on information in the beacon, (i.e. an indication that change information is pending or no change information is pending and what kind of change is pending), determine if specific components within the device can remain in a sleep mode and what components should be powered up to process “new” network information. Some status change transmission may be unimportant and thus a certain class of beacons could be ignored by the sleeping devices. Thus, when the change indicator is present, network device 103 can process the new data regarding the status of a device. However, when there is no change indicator present in the beacon or received by a network enabled device, the high power and inefficient components within the network device can remain in an off state. Such high power components in the baseband chain can include analog to digital converters fast Fourier transform processors, decoders etc.

The network 100 can interconnect all computing and communication devices that are authorized and can communicate in a wireless manner but this disclosure should not be limited to wireless devices as hard-wired devices or dual mode devices (wired and wireless) could also utilize the teachings herein. Many wireless standards and technologies exist for initiating communications between network devices. The disclosure herein can be utilized by many if not all such known standards and technologies. For example, the wireless media (WiMedia) media access control (MAC) standard, as defined in the European Computer Manufacturers Association (ECMA)-368 specification. The ECMA-368 WiMedia MAC specification supports simultaneous use of multiple protocols, such as IP networking, Wireless USB™, Wireless 1394™, Bluetooth™, and other protocols that can operate utilizing an ultra wide band (UWB) physical layer (PHY) protocol. Other technologies such as radio frequency identification (RFID), standards and standards promulgated by the multi-band orthogonal division multiplexing alliance (MBOA) could also apply to the present disclosure.

The “beaconing process” can be facilitate network organizational procedures that include device discovery, device connection setup, quality of service (QoS) reservations setup, and other connection parameter data. The WiMedia MAC protocol also defines a “superframe” to organize communications between devices. More specifically, a superframe defines a time period having defined time slots for specific types of transmissions (timing allocations for devices to transmit specific types of information). During the beaconing/set-up procedure devices entering the network 100 can be assigned different time slots in the superframe. For example, devices can be assigned time slots during a dynamic beaconing slot period of the superframe.

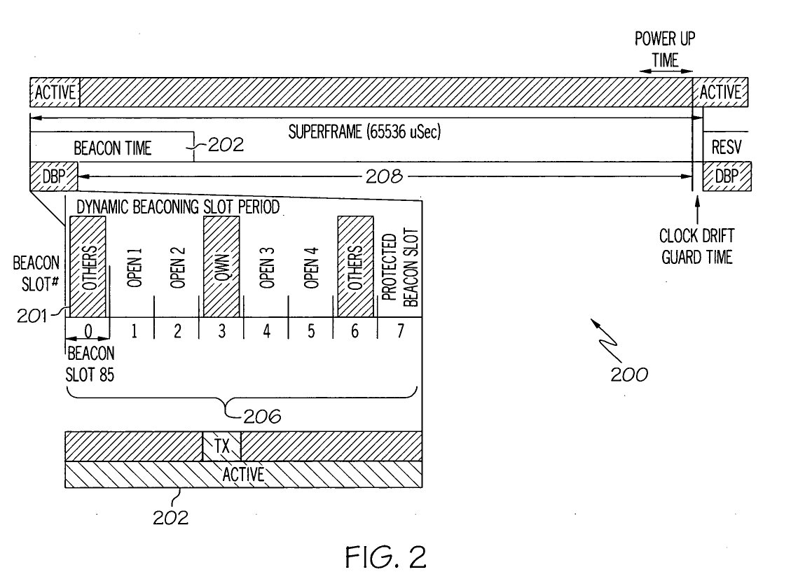

Referring briefly to FIG. 2, a superframe 200 is illustrated. The superframe 200 defines, among other things, a beacon time 202 preamble periods such as preamble period 201, and the dynamic beaconing slot period (DBSP) 204. The portion of the superframe 200 that is not part of the preamble 201 and the DBSP 204 is illustrated by time frame 208. Generally, the superframe 200 can be dissected into parts based time divisions within the superframe 200. The beacon time 202 is depicted as expanded or “blown up” to illustrate the seven time slots 206. Such slots 206 are time reserved for network devices to send a preamble and their own beacon and to receive beacons from other devices. Each beacon shown in transmit slot 0 slot 3 and slot 6 can include a preamble, where the preamble such as preamble 201 is a small time portion at the beginning of the beacon that is not cross hatched. Thus, an initial portion of a beacon can include a preamble to activate specific correlators.

The rest of, or balance of the superframe 200 can be utilized for network devices to exchange data, perform error detection and correction etc. In accordance with ECMA-368, a superframe 200 can have a duration of 65,536 microseconds. The DBSP 204 portion of the superframe 200 can consist of between 3 to 48 beacon slots which each are 85 microseconds in length. In the illustrated embodiment, DBSP 204 includes seven slots for seven different network devices. During a “discovery” phase, where new devices are attempting to join the network, each device can power up its receiver components and beacon processing components and listen on different channels, possibly sequentially, for one or more superframe(s) to determine if one of more network devices are in range and what channels the device(s) are utilizing.

After connections are made between network devices, the devices can go into a power conservation or sleep mode where possibly a majority of the devices components are turned off to conserve power. Periodically, during the beaconing process, devices will come out of their sleep mode and if there are no changes, the devices will transmit previously transmitted beacons to keep communication going within the network. In accordance with the present disclosure, a proactive indicator can be placed in the preamble such as preamble 201 to indicate that there is no new information in the beacon or that the beacon is a re-transmission. In other embodiments a composite preamble can further indicate what category the subsequent change information affects. Transmitting such a proactive or anticipatory indicator allows receiving network devices to receive the indicator early in the reception of the superframe, and allows devices to remain in a sleep mode if possible, thereby conserving significant power. In the disclosed embodiment, the transmission of the indicator can be done during a preamble, in other systems it could merely be placed in the initial portion of the transmission.

In accordance with the present disclosure the composite preamble can take many shapes and forms. Depending on the number of alternate preambles utilized, the transmitting network device could indicate the type of information that has changed with respect to prior beacons utilizing a digital sequence at particular time-location in the preamble. More particularly, the preamble or digital sequence could signal one of the following three major types of changes: (a) reservation changes, (b) IP traffic indications changes, and (c) informative changes. Knowing the type of change pending would allow proactive logic module to direct the proper circuits to “power up” from low-power mode based on this beacon modification beacon “change” information. Thus, the network device could be selective in what portions to power up based on what changes are pending. This selective or specialized embodiment can allow an additional power savings. The far majority of operating time, components, portions of subsystems, or entire subsystems within the network devices that process beacon data can be placed in such a sleep mode to conserve battery power.

When a transceiver, a proactive correlator and a PPLM detect that the received beacon portion contains “network status change information” by extracting such preamble information the baseband chain can be activated to receive and process the beacon signal. After the device is connected to the network, the proactive correlators can continuously receive beacons or “listen” for transmission made on numerous channels by various devices either connected to the network or attempting to connect to the network. Such transmission can be in compliance with and support physical layer “PHY” information in accordance with the level one specification of the seven level International Organization for Standardization (ISO) for the exchange of information model of computer networking.

In many UWB systems such as the one disclosed there can more than 30 unique channels that can be utilized for transmitting and receiving data. During idle operation, each proactive correlator can listen for transmissions on one channel for the duration of the beacon period. This receive mode is turned off when the device transmits its own beacon. As stated above, the beacon which is transmitted by a device can contain information about the device, the reservations for that device, information about neighbors etc. Generally, the beacon information will not change very regularly as in a steady state of the network beacon transmissions typically just a repeat of a previous beacon transmission.

When devices are powered up in range of each other or within range of a network a discovery phase can occur. During a discovery phase the legacy correlators 150 can operate to determine, based on a received preamble, if the subsequent beacon is required to be processed or if the beacon can be ignored. When the subsequent beacon can be ignored, the baseband receiver chain can remain off thereby providing substantial power savings.

The disclosed “sleep mode” can greatly reduce the average power consumed by a mobile network device. When a low power design is utilized for the preamble/monitoring/wake up circuit, the average power consumption of a device can be reduce by 75% over devices that maintain all components in a continuously powered state. The sleep mode/wake-up mode disclosed can be legacy compatible by utilizing synchronization preambles that can be processed by both a legacy receiver and a proactive receiver so that legacy devices can operate in the disclose network without problems.

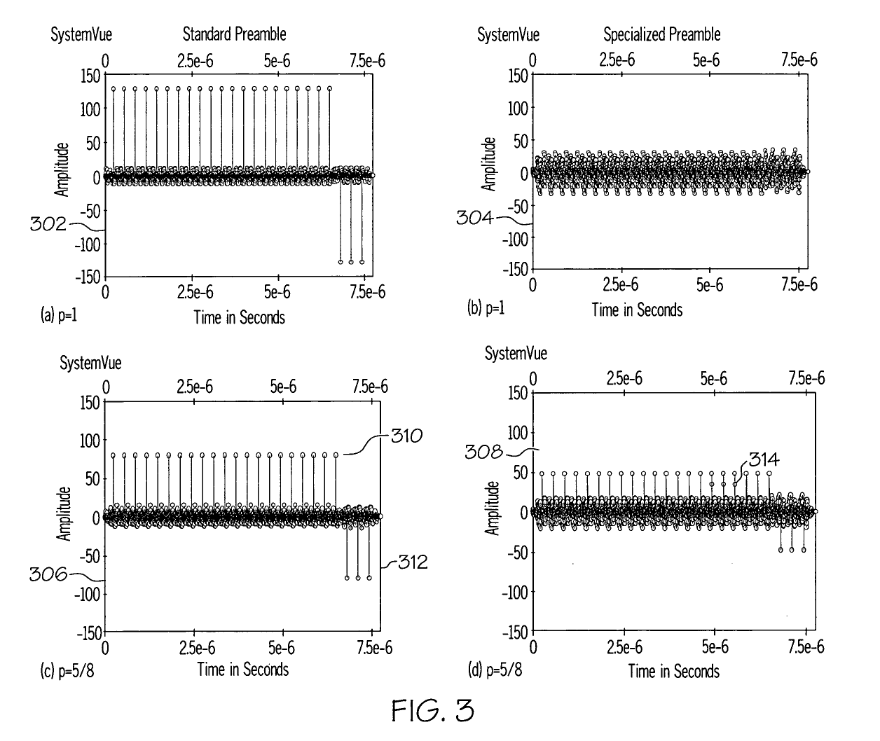

Referring to FIG. 3, different outputs of preamble correlators are illustrated. Alternate “status containing” preambles can take many different forms and only a few of such forms are described herein. Graph 302 and 306 illustrate legacy type preambles and graphs 304 and 308 illustrate composite preambles that contain “status” information. Status containing preambles can be constructed by many different hardware devices where only a few of which are described herein. For simplicity, each mode description below focuses on an example of a single alternate preamble, but one can appreciate that many such alternate preambles could be constructed, allowing for the multiple preambles as described below.

In one embodiment, reduce or varied signal strength of specific portions of the transmission in relation to other portions of the transmission is made while keeping signal strength within current industry standards. Accordingly there are many ways to include beacon status information into the preamble where this status information is “invisible” to legacy correlators but allow proactive correlators to detect such status indicators. The media access control processing portion of the device (i.e. 148 in FIG. 1) could utilize a composite preamble patterns to transmit and decode beacon status information that is additional to information exchanged between traditional or legacy network devices. The first level of utilization of the new indicators in the composite preamble could be utilized by a network enabled devices when sending a beacon to signal to the receiving network devices that the information contained in the beacon has no important changes and that the network enabled receiver should not receive/process the balance of information contained in the beacon. The transmission could include beacon sequence numbers and other information that is not essential for processing the medial access control layer of the transmission. A network compatible device could also use the standard preamble to indicate that the beacon contains changes and all of the neighbors (devices connected in the network should process this beacon to determine the changes.

In yet another embodiment, transmitter power reductions can also be achieved by transmitting stored “symbols” from the previous beacon. This allows for only the UWB AFE to be powered and allows the MAC and baseband portions (146 and 148 in FIG. 1) of the circuit to remain in low power operations during the entire beacon period. In fact, the disclosed system and arrangement allows the UWB MAC and baseband to remain in a low power operation during the entire superframe and possibly during the majority of superframes. Thus, the sleep mode can occur for numerous superframes until some information changes in a received beacon provided by a neighboring network device in which the receiving device needs to process the change and update its internal status of the network parameters.

By allowing MAC logic baseband receiver components to remain in low power mode for several superframes, significant power savings can be achieved. These savings allow UWB network devices to have idle-power levels that are similar to or less than those of other low-power technologies like Bluetooth. The disclosed system apparatus and process also allows backward-compatible preambles so that no changes are required such that legacy compliant network devices can still communicate in such a network environment.

In FIG. 3, outputs from a legacy preamble correlator and a proactive preamble correlator for the case of p=1 and p=⅝ are illustrated. Time in seconds is shown on the X-axis and amplitude in millivolts is shown in the y-axis. The proactive preambles illustrated by graphs 304 and 308 can be constructed such that they have improved transmission properties and can provide a “no-change” indicator during the beacon period. For example, let {Sa}={a0, a1, a2, . . . , a127} represent one of the seven 128-element “base time-domain sequences.” Such a configuration is described in Section 8.2 of the ECMA-368 standard published in December of 2005. All seven such sequences were specified with the understanding that an autocorrelation with low side lobes and a low cross-correlation as compared to the other six companion sequences in Section 8.2. of the specification is provided to minimize interference.

FIG. 3 in shows correlator outputs, 302 and 306 from the legacy preambles, and correlator outputs 304 and 308 from a composite preamble or proactive preamble. Each vertical line in the graph indicates that the correlator has detected the predetermined “shape” in the preamble. Generally, the preamble can be transmitted many times so that there are many vertical lines in the graph. So, graph 302 and 304 indicates that the preamble is not a composite preamble and does not have a change/no-change indicator and only a legacy correlator will detect the preamble. Graphs 306 and 308 indicate a composite preamble where not only the legacy correlator one but a proactive correlator can detect the preamble. The parameter “p” is to control the strength of the two components in the composite preamble.

To generalize the composite preamble sequence, the preamble can be defined by {Sx}=[p{Sa}+(1−p){Sb}] where p is on the interval [0,1]. Forming the alternate sequence in this weighted manner can assure that the transmitted composite preamble will have approximately the same average power as that of a standard preamble. It can be appreciated that for the special case of p=1, the alternate composite preamble reduces to the standard preamble {Sa}. Then for appropriate values for p<1, the alternate sequence {Sx} can be recognized by both the legacy preamble correlators and the proactive preamble correlators.

The value of p can be adjusted to avoid false or missed detections of the alternate preamble. In graphs, p=⅝ has been chosen as an example amplitude. The consequence of a missed detection does not have serious operational consequences as the receiver will “power up” as it normally would with any beacon and dissipate power. A device can transmit legacy-compatible beacons by utilizing legacy preamble correlators (such as item 1150 in FIG. 1) to allow a device to recognize, via the preamble only that a device is attempting to connect with the LAN. In accordance with the present disclosure, when a beacon is received that contains no new information relative to the last beacon transmitted, a receiver can leave most high-power consumption circuits in an “off” state.

In another example, let {Sb}={b0, b1, b2, . . . , b127} be one of several new proactive time-domain sequences with all the auto- and cross-correlation properties of {Sa} except that {Sb} is not one of the seven standard sequences. Proactive preamble correlators can detect these alternate sequences. It can be appreciated that, there is no firm limit on the number of alternate preambles that might be created by a system. This allows for multiple messages to be embedded in the preamble, possibly allowing future improvements in addition to the power-saving advantages disclosed herein. One expense to the disclosed system is that additional correlators may be needed and, depending on the value of p that is chosen, there may be some reduction in robustness of the standard preamble detection process.

Below another mode for a possible status containing preamble is disclosed. Such a preamble can utilize an alternate cover sequence that can indicate that no new information is being transmitted. A traditional cover sequence can consist of 1 and −1 and is to be multiplied to the preamble before transmission. For example, for transmit frequency code one (TFC1), the cover sequence is 21 “1's” followed by 3 “−1's.” This is the same preamble is sent 24 times, such that the first 23 transmissions of the preamble are sent as is (because it is x1) whereas the last 3 transmissions of the preamble are sign-reversed (because it is x−1). The correlator output shown in 302, illustrates this feature. The detection results for the first 21 preambles are positive and the detection results for the last 3 preambles are negative.

The mode does not require a proactive correlator. Instead, the arrangement modulates the cover sequence to indicate information. For example, a modulated cover sequence could be {1 1 1 1 1 1 1 1 1 1 1 1 1 1 1 1 0.5 0.5 0.5 1 1 1 −1 −1 −1}. Assuming no noise is added during the transmission, the output of the legacy correlator would be: {A A A A A A A A A A A A A A A 0.5A 0.5A 0.5A A A A −A −A −A}. Then, by looking at the output of the legacy correlator and confirming the prescribed change in amplitude, the legacy PA logic (144 in FIG. 1) can determine whether there will be a change in the following beacon contents or not. This other mode may appear to be more efficient, however is can be more susceptible to noise, in that the pattern in the amplitude wouldn't be that clear at the correlator output, making it difficult to clearly receive the indicator.

Such a status containing preamble can also allow a traditional or legacy ECMA compliant receiver to detect and acquire the required data from the preamble detection. As stated above the current ECMA-368 standard provides the standard cover sequence for TFC1 as can utilize a Telelocator Alphanumeric Protocol (TAP). An alternate cover sequence could be {15 1's then 0.5 0.5 0.5 1 1 1 −1 −1 −1} as illustrated by graph 308 with the modification shown by the half magnitude signals of, 314 (superimposed over full signals).

This cover sequence can provide virtually the same fully robust preamble detection as the traditional cover sequence and a correlator output as shown by the voltage time relationship in graph 308 as long as the half signals provided by the 314 modification are still within the lower value of the specification. Proactive correlator logic could distinguish such half levels and extract from these three bits what type of status information will be contained in the balance of the transmission.

As stated above in this status transmission mode or alternate mode, the proactive preamble detection logic can identify the preamble as “change detected” based on the amplitude reduction in the 16^{th} through 18^{th} correlator output peaks 314. It can also be appreciated that this proactive-cover-sequence mode has the advantage of requiring no additional correlators for such detection in legacy devices. It can be appreciated that variations on this status change mode could utilize other sequences without parting from the scope of the present disclosure. Orthogonal frequency division multiplexing (OFDM) based UWB systems or products could also utilize the teaching herein. When proactive preambles are utilized to indicate whether or not beacons have changed from prior beacons a definitive detection of such proactive preambles could be verified by performing the actual disassembly of baseband and MAC firmware.

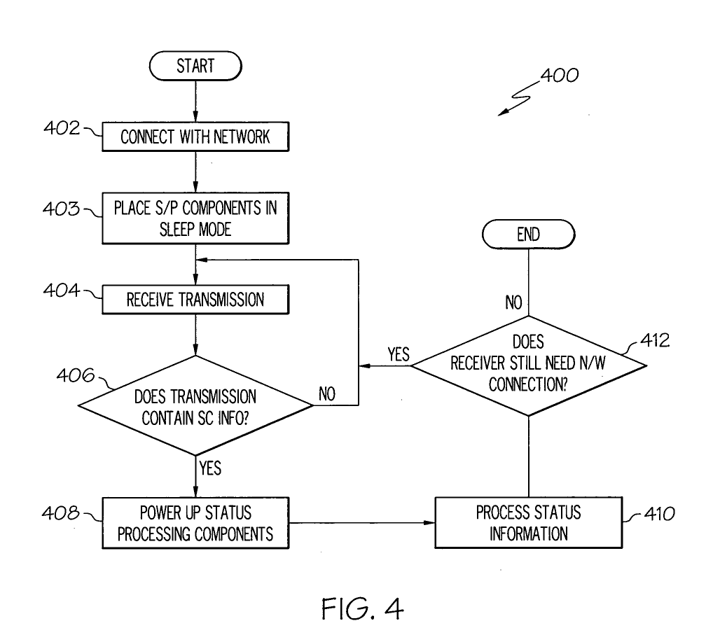

Referring to FIG. 4, a flow diagram of a method for conserving power while operating a network device is disclosed. In one embodiment, a network compatible device can connect with a network as illustrated by block 402. After a network connection is achieved by the device, the device can place specific components into a sleep mode as illustrated by block 403. In one embodiment the sleep mode can include deactivating at least one component of the battery powered device that at least partially assists in processing status change information. Such deactivation can place the component in a sleep mode by removing a clock signal at the input to a component of the device. Alternately, power can be removed from the component(s).

The device can then receive a signal transmission such as a preamble, as illustrated by block 404. Thus, the device can receive a communication with a communication configuration status indicator from a network compatible device. As illustrated by block 406, the device can determine if the transmission indicates that status change information is available or is forthcoming regarding a communication configuration. Accordingly, the device can detect an indication of a status change in the status communication that forewarns of specific configuration data that will be subsequently transmitted.

If the transmission does not contain a status change indicator, then the device can revert to block 404 where it can continue to receive transmissions and monitor the transmissions for status change indicators. As illustrated in block 408, if the transmission contains status change or configuration change information, then the device can power up components, some of which may have been placed into a sleep mode in accordance with block 403.

The beacon information can be processed by the components, and as illustrated by block 410, then the receiving device can determine if the device still requires a connection to the network as illustrated by block 412. If the device still requires a network connection then the process can revert to block 404 where transmission can continue to be received. If the device does not require a network connection or cannot achieve a network connection then the process can end.

In addition a network is described, however the teachings herein could be utilized for near field communications (NFC)s, wireless municipal area network (WMAN), a mesh network, cellular type communications, WiMax, radio access network for radio termination equipment (RAN-LTE), fourth generation wireless (4G), and other types of wireless and wired communication networks. In the embodiment illustrated, a UWB network is described however, this should not be considered as a limiting factor, as other types of devices and other types of network configurations could also utilize and benefit from the teachings herein.

Another embodiment of the disclosure is implemented as a program product for implementing a legacy compliant network with the systems and methods described with reference to FIGS. 1-4. The program(s) of the program product defines functions of the embodiments (including the methods described herein) and can be contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such data and/or signal-bearing media, when carrying computer-readable instructions that direct the functions of the present invention, represent embodiments of the present disclosure.

In general, the routines executed to implement the embodiments of the disclosure, may be part of an operating system or a specific application, component, program, module, object, or sequence of instructions. The computer program of the present invention typically is comprised of a multitude of instructions that will be translated by a computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the disclosure should not be limited to use solely in any specific application identified and/or implied by such nomenclature.

The present disclosure and some of its features have been described in detail for some embodiments. It should be understood that various changes, substitutions and alterations can be made herein without departing from the spirit and scope of the disclosure as defined by the appended claims. An embodiment of the disclosure may achieve multiple objectives, but not every embodiment falling within the scope of the attached claims will achieve every objective. Moreover, the scope of the present application is not intended to be limited to the particular embodiments of the process, machine, manufacture, composition of matter, means, methods and steps described in the specification. One of ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

What is claimed is:

1. A method comprising:
communicating with a network compatible device utilizing at least one communication configuration;
placing a component that processes communication configuration change data in a power conservation mode;
detecting an indicator in a transmission of a pending change to the communication configuration; and
activating the component in response to the detected indicator.

2. The method of claim 1, further comprising processing a transmission subsequent to detecting the indicator to determine a communication configuration change.

3. The method of claim 1, further comprising processing a beacon with the component.

4. The method of claim 1, further comprising receiving a transmission having communication configuration change classification information.

5. The method of claim 1, wherein the indicator is part of a preamble.

6. The method of claim 1, wherein the component comprises a baseband receiver chain.

7. The method of claim 1, wherein activating comprises activating a clock gate.

8. The method of claim 1, wherein the network compatible device is a European Computer Manufacturers Association Wireless Media, Media Access Control standard compliant device.

9. An apparatus comprising:
a correlator to receive a transmission having status information on a predetermined channel and to determine an indication of forthcoming network status change data;
an activation module coupled to the correlator to generate a control signal based on the indication; and
a status processing component to receive the control signal and to receive and process status information in response to the control signal.

10. The apparatus of claim 9, further comprising an ultra-wideband transceiver to receive the transmission.

11. The apparatus of claim 9, further comprising a media access control logic module to process the transmission.

12. The apparatus of claim 9, wherein the status processing component is a baseband receiver.

13. The apparatus of claim 9, wherein the transmission comprises a superframe.

14. The apparatus of claim 9, wherein the indication provides network status change classification data.

15. The apparatus of claim 14, wherein the network status change classification data includes one of a reservation change, an IP traffic change, or an informative change.
